(19) United States
(12) Patent Application Publication
(10) Pub. No.: US 2007/0281051 A1
(43) Pub. Date: Dec. 6, 2007

(54) ANGLE PIN ROLLER GUIDE

(76) Inventor: Anthony J. Cerniglia, Wauconda, IL (US)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 11/756,220

(22) Filed: May 31, 2007

Related U.S. Application Data
(60) Provisional application No. 60/810,203, filed on May 31, 2006.

(51) Int. Cl. B29C 45/40

(52) U.S. Cl. 425/441; 425/186; 425/DIG. 58; 425/DIG. 1; 249/63; 249/66.1

(57) ABSTRACT

An angle pin roller guide is disclosed. A slide has at least one angle pin receiving hole for receiving an angle pin. Adjacent to the angle pin receiving hole is at least one pair of roller bearings mounted in the slide. Movement of the angle pin in a first direction imparts a force on the roller bearings, which results in a corresponding movement of the slide in second direction, which is substantially perpendicular to the first direction. Two or more sets of roller bearings can be staggered relative to the movement of the angle pin such that the corresponding movement of the slide varies with the degree of stagger between the sets of roller bearings.

### CROSS-REFERENCE TO RELATED APPLICATION

This application claims the benefit of U.S. Provisional Application No. 60/810,203, filed on May 31, 2006, which is hereby incorporated by reference in its entirety.

### BACKGROUND OF THE INVENTION

The present invention relates to injection molding devices, and more specifically to a roller guide for an angle pin of an injection molding machine.

### DESCRIPTION OF THE RELATED ART

In typical injection molding machines, the mold cavity is created from plates that abut each other at a parting line. When the mold is opened, these plates move apart from one another such that the molded part can be removed or ejected. In many injection molds, the mold cavity is further defined by one or more pieces that move perpendicular to the plates as the mold is opened and closed. These perpendicularly moving pieces are attached to slides which typically are moved by angle pins. The angle pin is received through an angled bore extending through the slide. In normal opening movement of the mold, the angle pin forces the slide laterally away from the molded piece along a guided path. An angle pin assembly of this type is disclosed in U.S. Pat. No. 5,234,329, issued to Vandenberg.

However, there are several drawbacks to the use of angle pins in this manner. First, the angle pin and the angle pin bore must be carefully aligned. Misalignment of the angle pin and the angle pin bore can result in a variety of failures. These failures include bending and or breaking of the angle pin, and galling of the angle pin and or the angle pin bore due to uneven wear and contact. Additionally, lubricants are needed to smooth the operation of the angle pin/slide mechanism. These lubricants can contaminate the piece being molded, which is particularly undesirable in clean room and medical mold applications.

To ease the alignment tolerances required for the angle pin and the angle pin bore, some injection mold makers will grind, machine, or otherwise change the shape of the angle pin tip to from a rounded or bullet nosed angle pin tip. However, these processes often result in removing portions of the angle pin that are hardened by the manufacturer. By removing or altering the hardened surface of the angle pin tip, the resultant tip may not have the hardened properties needed to reduce wear and or galling.

Another drawback of current angle pin technology is that the slide movement is controlled only by the angle of the angle pin. A steeply angled angle pin results in short movement of the slide and a shallower angled angle pin results in further movement of the angle pin. However, regardless of the angle pin angle, the movement of the slide is linear, in that the slide moves a specified lateral distance for a corresponding vertical movement of the angle pin. Thus using current angle pin technology, nonlinear movement of the slide is not possible. Furthermore, as the angle of the angle pin is increased, as would be needed for greater movement of the slide, the stresses on the pin increase. As a result, using current angle pin guide technology there is a natural limit to the angle of the angle pin, generally on the order of about fifteen degrees, before more complex operations, such as the use of hydraulically operated side actions, are employed.

There remains a need for angle pin guide technology that offers improved performance over the current angle pin guide technology, namely improved manufacturing and assembly tolerances and reduction of angle pin failures such as bending, braking or galling. There also remains a need for angle pin guide technology that offer variable movement of the slide. There also remains a need for angle pin guide technology that reduces or eliminates the need for lubricants in the angle pin/slide mechanism.

### SUMMARY

In view of the deficiencies described above, it is an object of the present invention to provide an angle pin guide technology that offers improved performance over the current angle pin guide technology, namely improved manufacturing and assembly tolerances, reduction of angle pin failures such as bending, braking or galling.

It is a further object of the present invention to provide an angle pin guide technology that offers variable movement of the slide.

It is a further object of the present invention to provide an angle pin guide technology that reduces or eliminated the need for lubricants in the angle pin/slide mechanism.

The present invention is an angle pin roller guide. A slide has at least one angle pin receiving hole for receiving an angle pin. Adjacent to each the angle pin receiving hole is at least one pair of roller bearings mounted in the slide. Preferably the roller bearings are mounted below the top surface of the slide. Mounting the roller bearings in such a manner can be achieved in various ways.

In operation, the movement of the angle pin in a first direction imparts a force on the roller bearings, which results in a corresponding movement of the slide in second direction, which is substantially perpendicular to the first direction. For example, vertical movement of the angle pin results in horizontal movement of the slide.

The use of roller bearings has several advantages. First, the use of roller bearings reduces the risk of galling to the angle pin and the slide. Second, the use of roller bearings may reduce or eliminate the need for lubricants to be used in the slide action, which is desirable for clean room and medical mold applications. Third, the use of roller bearings also reduces bending and braking of the angle pin because of the rolling nature of the roller bearing. Another advantage of using roller bearings to affect movement of the slide is the ability to vary the movement of the slide for a given angle pin. Two or more sets of roller bearings can be staggered relative to the movement of the angle pin. As the force imparted by the angle pin transitions from one set of roller bearings to the other set of roller bearings, the corresponding movement of the slide varies with the degree of stagger between the sets of roller bearings.

Other features and advantages of the invention will be apparent from the following detailed description taken in conjunction with the following figures, wherein like reference numerals represent like features.

### BRIEF DESCRIPTION OF THE FIGURES

FIG. 1 shows a perspective view of a slide having an angle pin roller guide according to the present invention.

FIG. 2 shows a perspective view of an alternate embodiment of a slide having an angle pin roller guide according to the present invention.

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

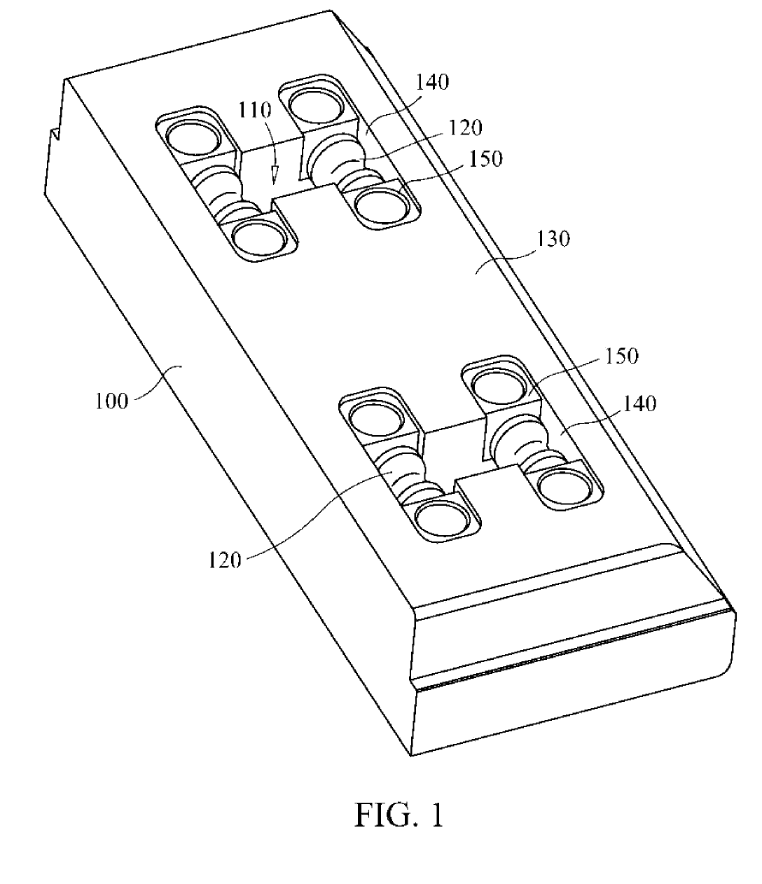

The present invention is an angle pin roller guide. FIG. 1 shows a perspective view of a slide having an angle pin roller guide according to the present invention. As shown, the slide 100 has two angle pin receiving holes 110 for receiving an angle pin. Those skilled in the art will recognize that the number and position of the angle pin receiving holes 110 is arbitrary and merely exemplifies the present invention. The angle pin receiving holes 110 can be formed in the slide 100 using milling and machining techniques known in the art. However, as the angle pin receiving holes 110 do not bear the force of the angle pin to move the slide 100 during the molding operation, the tolerances for making the angle pin receiving holes can be greatly relaxed. Thus, the milling and machining operations used to create the angle pin receiving holes 110 in the slide 100 can be simplified.

Adjacent to each angle pin receiving hole 110 is at least one pair of roller bearings 120 mounted in the slide 100. In various preferred embodiments the roller bearings 120 have a concave shape, which compliments the round shape of the angle pins. Preferably the roller bearings 120 are mounted just below the top surface 130 of the slide 100. Mounting the roller bearings 120 in such a manner can be achieved in various ways. For example, a pocket 140 can be machined or milled into the slide 100 for receiving the roller bearing 120 and any needed mounting hardware. This mounting hardware can include roller bearing mounts 150 which secure the roller bearing 120 and provide means for securing said roller bearing 120 to the slide 100.

In operation, the movement of the angle pin in a first direction imparts a force on the roller bearings 120, which results in a corresponding movement of the slide 100 in second direction, which is substantially perpendicular to the first direction. For example, vertical movement of the angle pin results in horizontal movement of the slide 100.

The use of roller bearings 120 has several advantages. First, the use of roller bearings 120 reduces the risk of galling to the angle pin and the slide 100 because the contact between the angle pin and the roller bearing 120 is a rolling contact as opposed to the pure sliding of the current angle pin guide technologies. Second, the use of roller bearings 120 may reduce or eliminate the need for lubricants to be used in the slide 100 action, which is desirable for clean room and medical mold applications because the roller bearing 120 itself rolls, the contact friction between the angle pin and roller bearing is reduced, thus reducing the need for other lubricants. Third, the use of roller bearings 120 also reduces bending and braking of the angle pin because of the rolling nature of the roller bearing 120, a slightly misaligned angle pin that would dig our gouge into the angle pin receiving hole of the current angle pin guide technologies is still able to roll along the roller bearing 120 of the present invention.

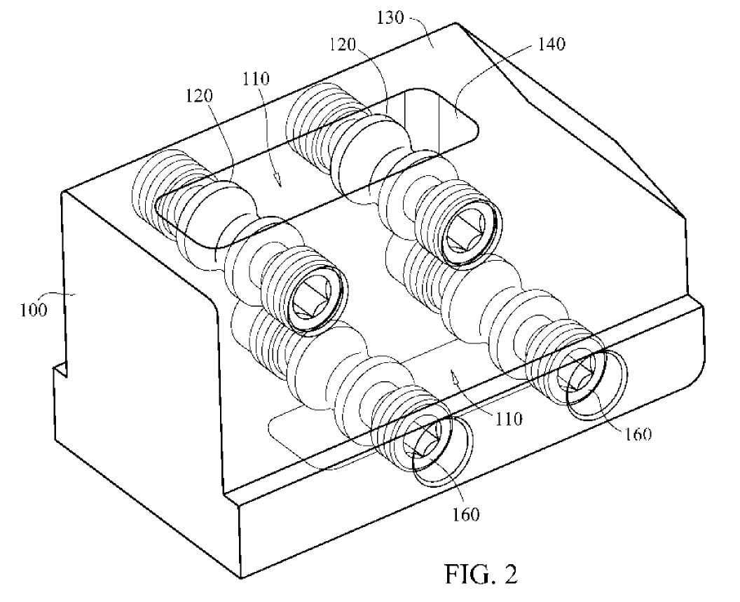

Another advantage of using roller bearings 120 to affect movement of the slide 100 is the ability to vary the movement of the slide 100 for a given angle pin. FIG. 2 shows a perspective view of an alternate embodiment of a slide having an angle pin roller guide according to the present invention. In this alternate embodiment, a single angle pin receiving hole 110 is shown. Two sets of roller bearings 120 are shown in the slide. As shown, the roller bearings 120 are mounted using threaded connectors 160 that are mounted into the sides of the slide 100, thus demonstrating an alternate type of mounting hardware. The two sets of roller bearings 120 can be staggered relative to the movement of the angle pin. As the force imparted by the angle pin transitions from one set of roller bearings 120 to the other set of roller bearings 120, the corresponding movement of the slide 100 varies with the degree of stagger between the sets of roller bearings 120. Additional pairs of roller bearings 120 may be used to vary movement of the slide 100 as needed for a particular application.

Yet another advantage of using roller bearings 120 to affect movement of the slide 100 is ability to have an increased angle pin angle. As discussed above, an increased angle pin angle results in greater movement of the slide 100. The increased performance of the roller bearings 120 to move the slide 100, also discussed above permits an increase in the angle pin angle to twenty or even thirty degrees. This increased angle pin angle permits the use of conventional side actions, albeit with the roller pin guides of the present invention, where previously more complex side actions, such as hydraulic side actions, would have to be used.

While specific embodiments have been illustrated and described, numerous modifications come to mind without significantly departing from the spirit of the invention and the scope of protection is limited by the scope of the accompanying claims.

What is claimed is:

1. An angle pin roller guide for an injection molding machine comprising:
a slide having a least one angle pin receiving hole,
at least one pair of roller bearings mounted in said slide for rollingly engaging an angle pin, wherein movement of said angle pin in a first direction imparts a force on one of said pair of said roller bearing which results in movement of said slide in a second direction, said second direction substantially perpendicular to said first direction.

2. The angle pin roller guide for an injection molding machine according to claim 1, wherein each of said roller bearing is mounted in a pocket in said slide and secured by at least one roller bearing mount.

3. The angle pin roller guide for an injection molding machine according to claim 1, wherein threaded connectors mounted into at least one side of said slide secure each of said roller bearings.

4. The angle pin roller guide for an injection molding machine according to claim 1, further comprising at least a second pair of roller bearings mounted in said slide.

5. The angle pin roller guide for an injection molding machine according to claim 1, wherein at least one pair of roller bearing comprises at least a first pair of roller bearings and at least said second pair of roller bearings,
said first pair of roller bearings and said second pair of roller bearings are staggered in said slide relative to said movement of said angle pin.

6. The angle pin roller guide for an injection molding machine according to claim 1, wherein said roller bearings have a concave shape.

7. An injection molding machine comprising:
a slide having a least one angle pin receiving hole,
at least one pair of roller bearings mounted in said slide for rollingly engaging an angle pin, wherein movement of said angle pin in a first direction imparts a force on at least one of said pair of said roller bearing which results in movement of said slide in a second direction, said second direction substantially perpendicular to said first direction.

8. The injection molding machine according to claim 7, wherein each of said roller bearing is mounted in a pocket in said slide and secured by at least one roller bearing mount.

9. The injection molding machine according to claim 7, wherein threaded connectors mounted into at least one side of said slide secure each of said roller bearings.

10. The injection molding machine according to claim 7, further comprising at least a second pair of roller bearings mounted in said slide.

11. The injection molding machine according to claim 7, wherein at least one pair of roller bearing comprises at least a first pair of roller bearings and at least said second pair of roller bearings,
said first pair of roller bearings and said second pair of roller bearings are staggered in said slide relative to said movement of said angle pin.

12. The injection molding machine according to claim 7, wherein said angle pin has an angle pin angle in the range of about 1 degree to about 15 degrees.

13. The injection molding machine according to claim 7, wherein said angle pin has an angle pin angle in the range of about 15 degree to about 20 degrees.

14. The injection molding machine according to claim 7, wherein said angle pin has an angle pin angle in the range of about 20 degree to about 30 degrees.

15. The injection molding machine according to claim 7, wherein said roller bearings have a concave shape.
